(19) United States
(12) Patent Application Publication
(10) Pub. No.: US 2009/0064108 A1
(43) Pub. Date: Mar. 5, 2009

(54) Configuring Software Stacks

(75) Inventors: Dallas De Atley, San Francisco, CA (US); Scott Herz, San Jose, CA (US); Andrew Platzer, Santa Clara, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/173,957

(22) Filed: Jul. 16, 2008

Related U.S. Application Data
(60) Provisional application No. 60/969,855, filed on Sep. 4, 2007.

(51) Int. Cl. G06F 9/44

(52) U.S. Cl. 717/121

(57) ABSTRACT

The present disclosure is directed to a system and method for configuring software stacks. In some implementations, a method for configuring devices includes automatically identifying one or more applications in the software stack based, at least in part, on at least one of a plurality of identifiable device models or types. The software stack is stored in a device. The one or more applications is automatically configured for execution in the device in accordance with the identified device model. Each of the plurality of identifiable device models is associated with a different configuration of the software stack.

### CLAIM OF PRIORITY

This application claims priority under 35 USC §119(e) to U.S. Patent Application Ser. No. 60/969,855, filed on Sep. 4, 2007, the entire contents of which are hereby incorporated by reference.

### TECHNICAL FIELD

This invention relates to software stacks.

### BACKGROUND

Modern mobile devices can provide a number of services, including telephony services, short messing service (SMS), media-player services, image/video services and e-mail communication. Both the software and the hardware of such devices include specific configurations. For example, configuration of software in a conventional device requires separate software builds for each device. Conventionally, the specific software bundles are loaded at the time the device is manufactured. Accordingly, device configuration at the manufacturing stage typically requires at least one factory line for each type of device.

### SUMMARY

The present disclosure is directed to a system and method for configuring software stacks. In some implementations, a method for configuring devices includes automatically identifying one or more applications in the software stack based, at least in part, on at least one of a plurality of identifiable device models or types. The software stack is stored in a device. The one or more applications is automatically configured for execution in the device in accordance with the identified device model. Each of the plurality of identifiable device models is associated with a different configuration of the software stack.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a block diagram for automatically configuring a software stack;

FIG. 2A is a block diagram of an example mobile device;

FIG. 2B is a block diagram of an example mobile device;

FIG. 3 is a flowchart illustrating an example method for automatically configuring a software stack in accordance with device model;

FIG. 4 is a flowchart illustrating an example method for automatically configuring a software stack in accordance with device type; and

FIG. 5 is a flowchart illustrating an example method for loading a software stack in different devices.

Like reference symbols in the various drawings indicate like elements.

### DETAILED DESCRIPTION

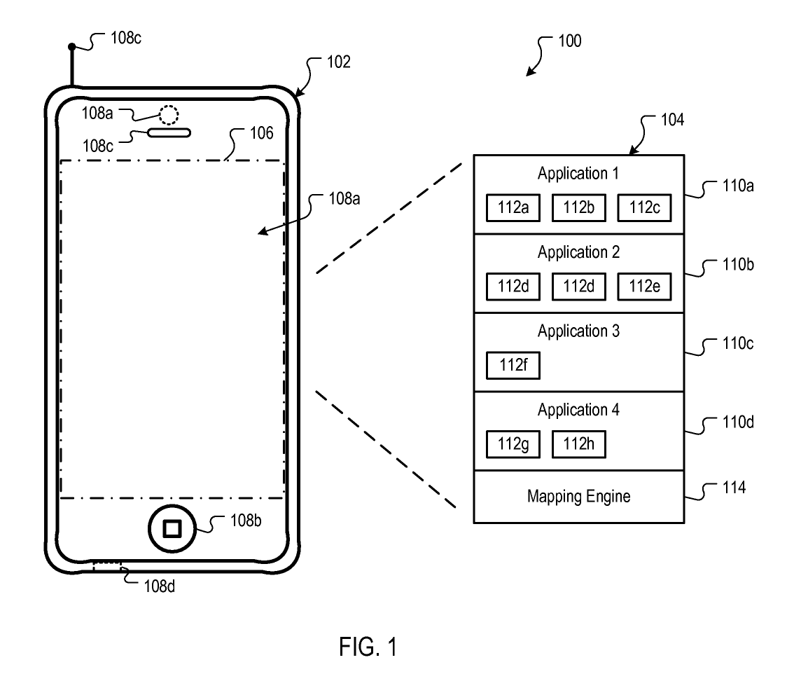

FIG. 1 illustrates a block diagram of an example system 100 for configuring a software stack. For example the system 100 may automatically configure a subset of applications in a software stack and associated properties of the applications based, at least in part, on a model or type of device. In this example, the device executes or otherwise includes a software stack. In general, a software stack includes a plurality of applications that may be executed on one or more devices. For example, the plurality of applications may include one or more of the following: a phone application, a user interface application, a camera application, Global Positioning System (GPS) application, a media application, and/or others. In some implementations, the system 100 may automatically configure, set, or otherwise identify those applications in the software stack allowed, authorized, or otherwise executable on one of a plurality of different device models or types. For example, the system 100 may configure a subset of applications in the software stack for execution in one model of a mobile device independent of configuring the remaining applications. In this example, the system 100 enables the mobile device to execute and/or configure specified applications in the software stack while effectively preventing execution and/or configuration of the other applications in the stack. In addition, the system 100 may automatically configure properties of the specified applications in accordance with the device model/type. For example, the system 100 may configure a media application to process both multimedia and image files for one device model (e.g., iPod video) while configuring a media application to process only image files for a second device model (e.g., iPod fourth generation). By dynamically configuring a software stack for different models at a time other than build, the system 100 can, in some implementations, provide a single software stack to any of a plurality of different models of a device and automatically configure the specified applications and associated properties based, at least in part, on the model/type of the device. In other words, the system 100 can, in some implementations, eliminate, minimize, or otherwise reduce the need for different software stacks for each of the device models.

At a high level, the system 100 can, in some implementations, include a mobile device 102 and a software stack 104. While illustrated as a mobile device 102, the system 100 can include other devices without departing from the scope of the disclosure (e.g., desktop computer). In the illustrated implementation, the mobile device 102 includes a Graphical User Interface (GUI) 106 and a plurality of hardware components 108a-e. The software stack 104 includes applications 110a-e, having a plurality of properties 112, and a mapping engine 114. As for a high level description of operation, the mapping engine 114 determines or otherwise identifies a model/type of the mobile device 102 in response to any suitable event (e.g., initialization, activation). Based, at least in part, on the identified model/type, the mapping engine 114 may automatically map the device model to one or more of the applications 110. For example, the mapping engine 114 may map a subset of the applications 110 to the device model. In addition, the mapping engine 114 may automatically map the device model to one or more properties 112 of the identified applications 110. In connection with identifying the applications 110 and associated properties 112 for the device model, the mapping engine 114 may automatically configure (or publish information to allow a respective application to self-configure) the identified applications 110 and associated properties 112 for execution on the mobile device 102 independent of configuring those applications not mapped to the device model. Indeed, the mapping engine 114 may configure less than all of the applications 110 for execution on the mobile device 102.

Turning to a high level description of the elements, the mobile device 102 can include any software, hardware, and/or firmware configured to execute one or more applications 110. The mobile device 102 can be, for example, a handheld computer, a personal digital assistant (PDA), a cellular telephone, a network appliance, a camera, a smart phone, an enhanced general packet radio service (EGPRS) mobile phone, a network base station, a media player, a navigation device, an email device, a game console, or a combination of any two or more of these data processing devices and/or other data processing devices. For example, the device 102 may be a cellular phone, a media player, an email device, and a navigation device operable to wirelessly connect with an external or unsecured network. In another example, the mobile device 102 may comprise a laptop that includes an input device, such as a keypad, touch screen, one or more scroll wheels, one or more buttons or other device that can accept information, and an output device that conveys information, including digital data, visual information, or GUI 106. Both the input device and output device may include fixed or removable storage media such as a magnetic computer disk, CD-ROM, flash, or other suitable media to both receive input from and provide output to users of mobile devices 102 through the display such as GUI 106.

The GUI 106 comprises a graphical user interface operable to allow the user of the mobile device 102 to interface with at least a portion of the system 100 for any suitable purpose, such as using applications 110. Generally, the GUI 106 provides the particular user with an efficient and user-friendly presentation of data provided by or communicated within the system 100. The GUI 106 may comprise a plurality of customizable frames or views having interactive fields, pull-down lists, and/or buttons operated by the user. The term graphical user interface may be used in the singular or in the plural to describe one or more graphical user interfaces and each of the displays of a particular graphical user interface. The GUI 106 can include any graphical user interface, such as a generic web browser or touch screen, that processes information in the system 100 and presents the results to the user.

The hardware components 108 provide one or more features and/or functions to the operation of the mobile device 102. For example, the hardware component 108 may be a camera configured to capture images and/or video. In the illustrated implementation, the hardware components 108 include a display 108a, a button 108b, a speaker 108c, a microphone 108d, a camera 108e, and an antenna 108f. These hardware components 108 are for illustration purposes only and the mobile device 102 may include all, some, or different hardware components 108 without departing from the scope of this disclosure. In some implementations, the hardware components 108 may include one or more of the following: motion sensors, light sensors, proximity sensors, camera, RF antenna, speakers, microphone, a display (e.g., touch screen), and/or other hardware. In addition, different models of the mobile device 102 may have different versions of the hardware components 108. In some implementations, the display 108a may be a touch screen for one model and a display for a different model. In some implementations, the camera 108e of one model may capture still images while the camera 108e of a different model may capture both still images and video (e.g., 30 frames/sec). In some implementations, the mobile device 102 may not include some hardware components 108 that other models include. For example, the mobile device 102 may not include the camera 108e. In short, the hardware components 108 may include the same, some, none, or different versions for different models of the mobile device 102.

The software stack 104 includes a set of applications 110 where each is assigned or otherwise associated with one or more models of the mobile device 102. In general, the set of applications 110 include any suitable application software configured to run on at least one model/type of the mobile device 102. For example, an application 110 may comprise a device driver configured to enable higher-level software programs to interact with one or more hardware components 108. In some implementations, one or more of the set of applications 110 may be software programs that process information captured, received or otherwise identified by the hardware component 108. For example, an application 110 may be a media player that produces audio signals based, at least in part, on audio files received by the antenna 108f. In some implementations, an application 110 may be software program configured to present and/or modify images captured by the camera 108e. The set of applications 110 may include software programs associated with one or more of the following: an operating system, wireless communication, GUI 106, sensors, images, electronic messaging, web browsing, media processing, GPS/Navigation, camera, and/or other hardware components 108 and/or software programs. The set of applications 110 may be based on any appropriate computer language such as, for example, C, C++, Java, Perl, Visual Basic, 4GL, and/or others.

In addition, the set of applications 110 may include properties 112. In this implementation, the properties 112 may be configured based, at least in part, on the model/type of the mobile device 102. For example, two different models of the mobile device 102 may include the same application 110 but have different properties 112 and/or different configurations of the properties 112. In some implementations, the properties 112 and/or the configuration of the properties 112 may be based, at least in part, on the version of a hardware component 108. As mentioned above, the hardware components 108 may include different versions for the different models of the mobile device 102. In this implementation, the different properties 112 and/or different configurations of the properties 112 may associated with the models. For example, the hardware component 108 may be a portion of a wireless phone such that one model wirelessly communicates using CDMA and a different model wirelessly communicates using GSM. In this case, an application 110 may include a property 112 associated with processing CDMA frames and a different property 112 associated with processing GSM packets. In another example, the display 108a may be a non-interactive display for one model and a touch-screen display for a different model. In this example, an application 110 may include a property 112 configured to process touches detected by the first model. In short, the properties 112 may determine one or more of the following: operation of hardware components 108; processing of information by applications 110; presentation of information through the display 108a; functionality of the applications 110 (e.g., services provided); how information is received from the user and/or through connections (e.g., wireless, USB); and/or others.

In one implementation, the mapping engine 114 is software configured to identify applications 110 associated with a model. For example, the mapping engine 114 may automatically identify a device model/type in response to an event (e.g., initialization) and automatically configure applications 110 associated with the model for execution on the mobile device 102. In some implementations, the mapping engine 114 may execute one or more of the following: identify a model of the mobile device 102 in response to at least an event; map the device model to one or more applications 110; map the device model to one or more properties 112 of the identified applications 110; identify configuration settings for the identified applications 110 and associated properties 112; automatically configure the applications 110 and properties 112 for execution in the mobile device 102 in accordance with the identified device model; and/or others. Alternatively, the mapping engine 114 may merely publish configuration settings and device model/type information that can be used by respective applications to configure correctly for a given device. In regards to identifying the model type, the mapping engine 114 may determine the device model from information independent of the software stack 104. For example, the mapping engine 114 may determine or otherwise identify the device model from any software, hardware, and/or firmware in the mobile device 102. In some implementations, the mapping engine 114 can determine the device model from locally stored software elements executed by the mobile device 102. For example, the mapping engine 114 may determine a device model based, at least in part, on a locally stored list (e.g., IOKit) of capabilities (e.g., camera, cellular radio). In some implementations, such list may be refined based on driver queries. In response to at least identifying the device model, the mapping engine 114 may determine the applications 110 associated with the model. For example, the mapping engine 114 may map the device model to one or more applications 110. In some implementations, the mapping engine 114 includes or otherwise identifies instructions for mapping the device model to applications. For example, the mapping engine 114 may include a list of device models and associated applications 110. In some cases, devices may be named such as M68AP or M68DEV (development board). In response to at least identifying a device, the mapping engine 114 may identify a plist of that name. In some implementations, a plist can include the capabilities of the device and other information. This plist may reference other devices. For example, a plist for an M68DEV device may identify the device as an M68AP with some extra debugging features. In this example, the M68DEV inherits from the M68AP plist with only a few changes. In some implementations, a device type may be changed or otherwise updated using a preference. In do so, a simplified plist may be specified lacking a certain capability prior to developing hardware of a device. In some implementations, the mapping engine 114 may identify mapping information in a separate file (not illustrated). In addition, the mapping engine 114 may map the device model to one or more properties 112 of the identified applications 110.

Turning to configuring the identified applications 110, the mapping engine 112 can, in some implementations, automatically configure the applications 110 and associated properties 112 in accordance with the device model. In some implementations, configuration instructions may identified and be based on one or more of the following: the version of hardware components 108 included in the mobile device 102; a level of service purchased by the user of the mobile device 102; and/or others. In some implementations, configuration instructions may be primarily based on hardware capabilities of a device such as camera, telephony, availablity of 30pin devices (iAP), and/or others. In some implementations, policy decisions may also be made such as iPod a single app (m68, ipod) or two apps (n45, Music, Video), rules for double tap, and/or others. In some implementations, geography based filtering (e.g., certain markets don't allow certain WiFi and cellular radios) can be based on the SKU and/or actual location. In some implementations, extra refinement of existing capabilities may be provided such as what generation cell radio is supported, VOIP, and/or others.

Screen geometry and display transforms In regards to hardware components 108, the mapping engine 112 may be configured to identify different configuration settings of a property 112 for different device models. For example, the mapping engine 112 may be configured to determine that a first model can detect two-fingered touches on the display 108a and a second model can only detect a single finger touch. In this example, the mapping engine 112 may configure a single property 112 associated with touch inputs in accordance with different instructions for the two models. In some implementations, the mapping engine 112 may identify a level of service associated with the user of the mobile device 102. In this implementation, the mapping engine 112 may configure two mobile devices 102 having the same device model differently in accordance with different service levels. For example, the mapping engine 112 may identify one or more different applications 110 to one service level as compared with a different service level for the same device 102. In this example, the mapping engine 112 may configure a word-processing application 110 to execute on a mobile device 102 based, at least in part, on a service level, but the mapping engine 112 may not configure the word-processing application 110 to execute for a different service level. In some implementations, the mapping engine 112 may configure one or more properties 112 differently based, at least in part, on the service level. For example, the mapping engine 112 may configure, in accordance with a service level, a property 112 of a word-processing program 110 that enables the user to edit documents, but the mapping engine 112 may configure a property 112 of the word-processing program 110 to only enable a user to read documents based, at least in part, on a different service level.

In one aspect of operation, the mapping engine 114 may automatically determine a device model in response to, for example, initialization of the mobile device 102. In connection with identifying the device model, the mapping engine 114 may map the device model to one or more applications 110 in the software stack 104. In addition, the mapping engine 114 may map the device model to one or more properties 112 and/or configuration of properties 112. In accordance with the mapping information, the mapping engine 114 may configure the one or more identified applications 110 for execution by the mobile device 102.

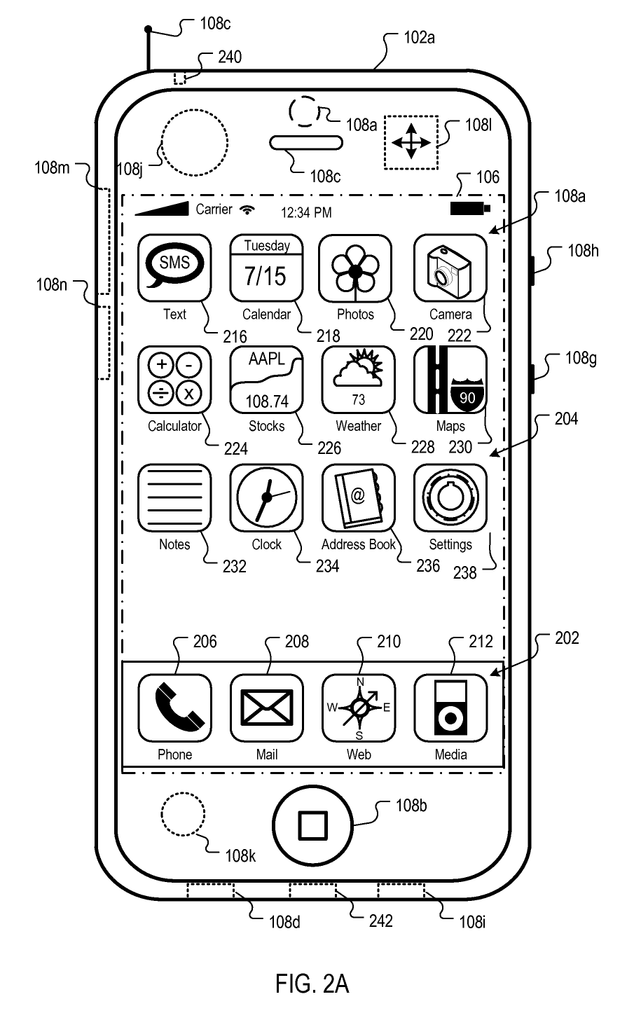

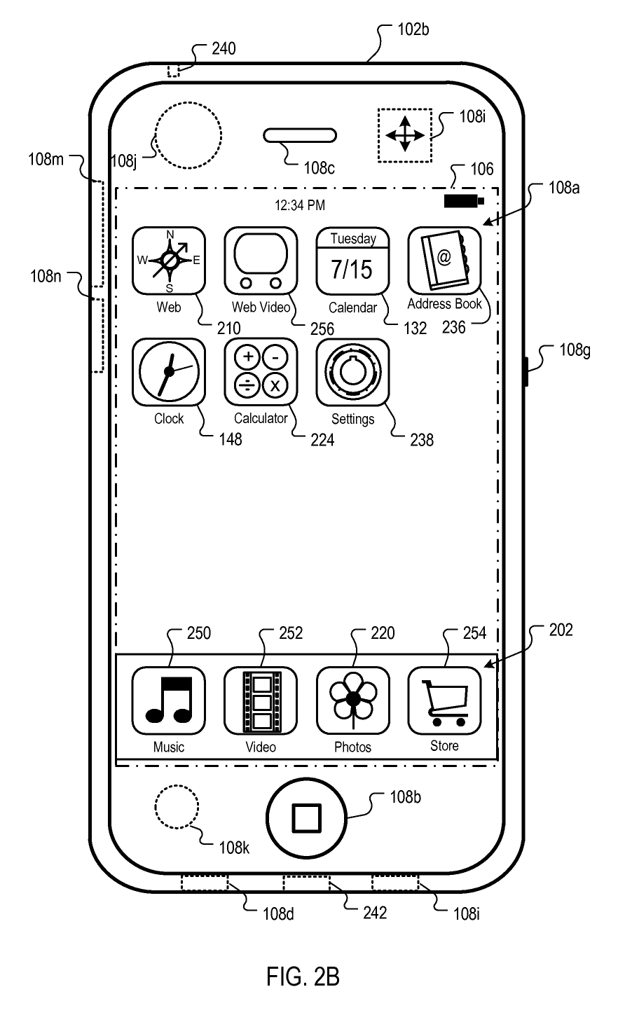

FIGS. 2A and 2B illustrate two different models of the mobile device 102a and 102b, respectively. In these examples, the system 100 automatically configures the applications 110 in the software stack 104 based, at least in part, on the two different models. As mentioned above, different models may include different hardware elements 110, different versions of hardware elements 110, different service levels, and/or other differencing aspects. Accordingly, the set of applications 110 and/or associated properties 112 may be selected and/or configured based, at least in part, on the hardware elements 110 included in the different models.

Turning to a description of the different mobile devices 102a and 102b, FIG. 2A is a block diagram of an example mobile device 102a. The mobile device 102a can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

In some implementations, the mobile device 102a includes a touch-sensitive display 108a. The touch-sensitive display 108a can implement liquid crystal display (LCD) technology, light emitting polymer display (LPD) technology, or some other display technology. The touch sensitive display 108a can be sensitive to haptic and/or tactile contact with a user.

In some implementations, the touch-sensitive display 108a can comprise a multi-touch-sensitive display 108a. A multi-touch-sensitive display 108a can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 102a can display one or more graphical user interfaces on the touch-sensitive display 108a for providing the user access to various system objects and for conveying information to the user. In some implementations, the graphical user interface can include one or more display objects 202, 204. In the example shown, the display objects 202 and 204 are graphic representations of system objects. Some examples of system objects include device functions, applications, windows, files, alerts, events, or other identifiable system objects.

In some implementations, the mobile device 102a can implement multiple device functionalities, such as a telephony device, as indicated by a phone object 206; an e-mail device, as indicated by the e-mail object 208; a network data communication device, as indicated by the Web object 210; a Wi-Fi base station device (not shown); and a media processing device, as indicated by the media player object 212. In some implementations, particular display objects 202, e.g., the phone object 206, the e-mail object 208, the Web object 210, and the media player object 212, can be displayed in a menu bar 202. In some implementations, device functionalities can be accessed from a top-level graphical user interface, such as the graphical user interface illustrated in FIG. 2A. Touching one of the objects 206, 208, 210, or 212 can, for example, invoke corresponding functionality.

In some implementations, the mobile device 102a can implement network distribution functionality. For example, the functionality can enable the user to take the mobile device 102a and provide access to its associated network while traveling. In particular, the mobile device 102a can extend Internet access (e.g., Wi-Fi) to other wireless devices in the vicinity. For example, mobile device 102a can be configured as a base station for one or more devices. As such, mobile device 102a can grant or deny network access to other wireless devices.

In some implementations, upon invocation of device functionality, the graphical user interface of the mobile device 102a changes, or is augmented or replaced with another user interface or user interface elements, to facilitate user access to particular functions associated with the corresponding device functionality. For example, in response to a user touching the phone object 206, the GUI 106 of the touch-sensitive display 108a may present display objects related to various phone functions; likewise, touching of the email object 208 may cause the graphical user interface to present display objects related to various e-mail functions; touching the Web object 210 may cause the graphical user interface to present display objects related to various Web-surfing functions; and touching the media player object 212 may cause the graphical user interface to present display objects related to various media processing functions.

In some implementations, the top-level graphical user interface environment or state of FIG. 2A can be restored by pressing a button 108b located near the bottom of the mobile device 102a. In some implementations, each corresponding device functionality may have corresponding “home” display objects displayed on the touch-sensitive display 108a, and the graphical user interface environment of FIG. 2A can be restored by pressing the “home” display object.

In some implementations, the top-level graphical user interface can include additional display objects 204, such as a short messaging service (SMS) object 216, a calendar object 218, a photos object 220, a camera object 222, a calculator object 224, a stocks object 226, a weather object 228, a maps object 230, a notes object 232, a clock object 234, an address book object 236, and a settings object 238. Touching the SMS display object 216 can, for example, invoke an SMS messaging environment and supporting functionality; likewise, each selection of a display object 216, 218, 220, 222, 224, 226, 228, 230, 232, 234, 236 and 238 can invoke a corresponding object environment and functionality.

Additional and/or different display objects can also be displayed in the graphical user interface of FIG. 2A. For example, if the device 102a is functioning as a base station for other devices, one or more “connection” objects may appear in the graphical user interface to indicate the connection. In some implementations, the display objects 204 can be configured by a user, e.g., a user may specify which display objects 204 are displayed, and/or may download additional applications or other software that provides other functionalities and corresponding display objects.

In some implementations, the mobile device 102a can include one or more input/output (I/O) devices and/or sensor devices. For example, a speaker 108c and a microphone 108d can be included to facilitate voice-enabled functionalities, such as phone and voice mail functions. In addition to the hardware components 108 illustrated in FIG. 1, the mobile device 102a may include one or more of the following hardware components: In some implementations, an up/down button 108g for volume control of the speaker 108c and the microphone 108d can be included. The mobile device 102a can also include an on/off button 108h for a ring indicator of incoming phone calls. In some implementations, a loud speaker 108i can be included to facilitate hands-free voice functionalities, such as speaker phone functions. An audio jack 240 can also be included for use of headphones and/or a microphone.

In some implementations, a proximity sensor 108j can be included to facilitate the detection of the user positioning the mobile device 102a proximate to the user's ear and, in response, to disengage the touch-sensitive display 108a to prevent accidental function invocations. In some implementations, the touch-sensitive display 108a can be turned off to conserve additional power when the mobile device 102a is proximate to the user's ear.

Other sensors can also be used. For example, in some implementations, an ambient light sensor 108k can be utilized to facilitate adjusting the brightness of the touch-sensitive display 108a. In some implementations, an accelerometer 108l can be utilized to detect movement of the mobile device 102a, as indicated by the directional arrows. Accordingly, display objects and/or media can be presented according to a detected orientation, e.g., portrait or landscape. In some implementations, the mobile device 102a may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 102a or provided as a separate device that can be coupled to the mobile device 102a through an interface (e.g., port device 242) to provide access to location-based services.

In some implementations, a port device 242, e.g., a Universal Serial Bus (USB) port, or a docking port, or some other wired port connection, can be included. The port device 242 can, for example, be utilized to establish a wired connection to other computing devices, such as other communication devices 102, network access devices, a personal computer, a printer, a display screen, or other processing devices capable of receiving and/or transmitting data. In some implementations, the port device 242 allows the mobile device 102a to synchronize with a host device using one or more protocols, such as, for example, the TCP/IP, HTTP, UDP and any other known protocol. In some implementations, a TCP/IP over USB protocol can be used, as described in U.S. Provisional Patent Application No. 60/945,904, filed Jun. 22, 2007, for “Multiplexed Data Stream Protocol,” Attorney Docket No. 004860.P5490, which provisional patent application is incorporated by reference herein in its entirety.

The mobile device 102a can also include a camera lens and sensor 108e. In some implementations, the camera lens and sensor 108e can be located on the back surface of the mobile device 102a. The camera can capture still images and/or video.

The mobile device 102a can also include one or more wireless communication subsystems, such as an 802.12B/g communication device 108m, and/or a Bluetooth™ communication device 108n. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

Referring to FIG. 2B is a block diagram of an example mobile device 102b. The mobile device 102b can be, for example, a handheld computer, a personal digital assistant, a network appliance, a camera, a network base station, a media player, a navigation device, an email device, a game console, or a combination of any two or more of these data processing devices or other data processing devices. In some implementations, the device 102b is an example of how the device 102b can be configured to display a different set of objects. In some implementations, the device 102b has a different set of device functionalities than device 102a of FIG. 2A such as some and/or different hardware components 108, applications 110, and/or properties 112.

In some implementations, the mobile device 102b includes a touch-sensitive display 108a, which can be sensitive to haptic and/or tactile contact with a user. In some implementations, the mobile device 102b can display one or more graphical user interfaces on the touch-sensitive display 108a for providing the user access to various system objects and for conveying information to the user.

In some implementations, the mobile device 102b can implement multiple device functionalities, such as a music processing device, as indicated by the music player object 250, a video processing device, as indicated by the video player object 252, a digital photo album device, as indicated by the photos object 218, and a network data communication device for online shopping, as indicated by the store object 254. In some implementations, particular display objects 202, e.g., the music player object 250, the video player object 252, the photos object 218, and store object 254, can be displayed in a menu bar 214. In some implementations, device functionalities can be accessed from a top-level graphical user interface, such as the GUI 106 illustrated in FIG. 2B. Touching one of the objects 250, 252, 218, or 254 can, for example, invoke corresponding functionality.

In some implementations, the top-level GUI 106 of mobile device 102b can include additional display objects 204, such as the Web object 208, the calendar object 216, the address book object 234, the clock object 232, the calculator object 222, and the settings object 236 described above with reference to mobile device 102b of FIG. 2A. In some implementations, the top-level GUI 106 can include other display objects, such as a Web video object 256 that provides functionality for uploading and playing videos on the Web. Each selection of a display object 208, 256, 216, 234, 232, 222, and 236 can invoke a corresponding object environment and functionality.

Additional and/or different display objects can also be displayed in the GUI 106 of FIG. 2B. In some implementations, the display objects 106 can be configured by a user. In some implementations, upon invocation of device functionality, the graphical user interface of the mobile device 102b changes, or is augmented or replaced with another user interface or user interface elements, to facilitate user access to particular functions associated with the corresponding device functionality.

In some implementations, the mobile device 102b can include one or more input/output (T/O) devices 108a, 108b, 108j, and 140, a volume control device 108g, sensor devices 108j-l, 108n, and 108e, wireless communication subsystems 108m and 108n, and a port device 242 or some other wired port connection described above with reference to mobile device 102a of FIG. 2A.

In short, the model of the mobile device 102b does not include several hardware components 108 included in the different model illustrated in FIG. 2A. For example, the mobile device 102b does not include the antenna 108f for wireless call sessions, the camera 108e, and a navigation component 108. In some implementations, the absence of these hardware components 108 enable the mobile device 102b to include different components 108 and/or different versions of other hardware components 108. For example, the mobile device 102b may include larger storage space for files such as audio and/or video files. Based, at least in part, on the differences in the hardware components 108, the software stack 104 of FIG. 1 can, in some implementations, be configured differently for the different models. For example, the mapping engine 114 may automatically configure different applications 110, different properties 112, and/or different settings of applications 110 and/or properties 112 for the different mobile devices 102a and 102b.

Turning to a description of operation of the software stack 104 of FIG. 1, the software stack 104 is loaded in both the mobile device 102a and the mobile device 102b independent of manual configuring the stack 104. In response to at least an event (e.g., initialization, activation), the mapping engine 114 residing in each model automatically identifies the device model/type. For example, the device model may be a string of characters locally stored in each device 102. The mapping engine 114 may automatically identify one or more applications 110 associated with the device model. For example, the mapping engine 114 executed by the mobile device 102a may identify an application 110 configured to manage cellular hardware components 110 for wirelessly communicating call sessions. In this example, the mapping engine 114 executed by the mobile device 102b does not identify the cellular application 110 because this device model does not include cellular hardware components 110.

In addition, the mapping engine 114 may identify instructions for setting one or more properties 112 for each of the identified applications 110. For example, the mapping engine 114 for each mobile device 102 may identify an application 110 for processing and/or managing locally stored video and audio files. In this example, the mapping engine 114 executed by the mobile device 102a may identify different instructions for setting the associated properties 112 than the mapping engine 114 executed by the mobile device 102b. For instance, the mobile device 102b may include a larger storage component 108 than the mobile device 102a. As result of this example difference, the mapping engine 114 may configure the same properties 112 of a media player application 110 differently for the different mobile devices 102. In connection with identifying the applications 110 and associated properties 112, the mapping engine 114 automatically configures the applications 110 and associated properties 112 for execution by the different mobile devices 102a and 102b. As mentioned above, the software stack 104 can, in some implementations, enable the development of a single software stack 104 that can be loaded in a plurality of different devices and automatically configure one or more of the applications 110 to execute on the different devices.

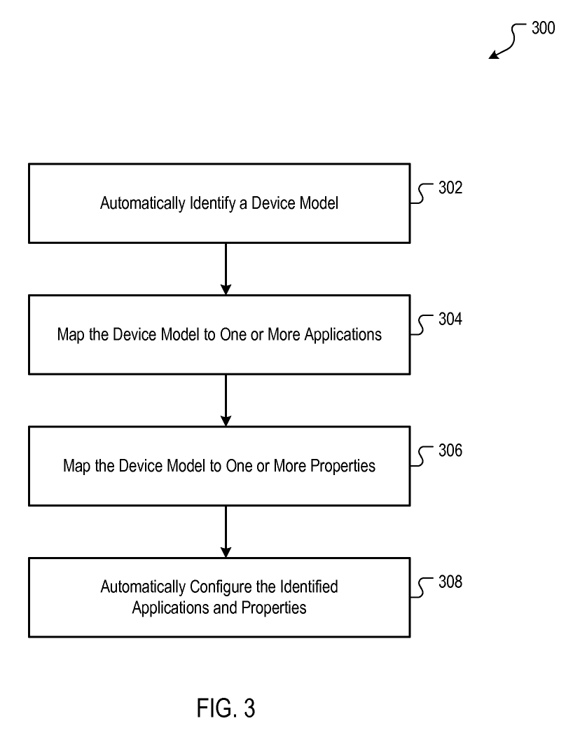

FIG. 3 is a flow chart illustrating an example method 300 for automatically configuring a software stack in accordance with some implementations of the present disclosure. Generally, method 300 describes an example technique where a single software stack automatically configures applications in accordance with one of a plurality of different device models. System 100 contemplates using any appropriate combination and arrangement of logical elements implementing some or all of the described functionality.

The method 300 begins at step 302 where a software stack automatically identifies a device model in response to an event. For example, the mapping engine 114 of FIG. 1 may automatically identify a device model of the mobile device 102 in response to at least initialization. At step 304, the device model is mapped to one or more applications in the software stack. In the example, the mapping engine 114 may map the device model to a subset of the applications 110 that is less than all of the applications 110. Next, at step 306, the mapping engine 114 maps the device model to one or more properties of the applications. As for the example, the mapping engine 114 may map the device model to one or more properties 112 of the identified applications 110, which may include identifying instructions for configuring the one or more properties 112. In accordance with the device model, the identified applications and properties are automatically configured for execution in the device at step 308. Returning to the example, the mapping engine 114 may automatically configure the identified applications 110 and properties 112 for executing by the mobile device 102 in accordance with the device model.

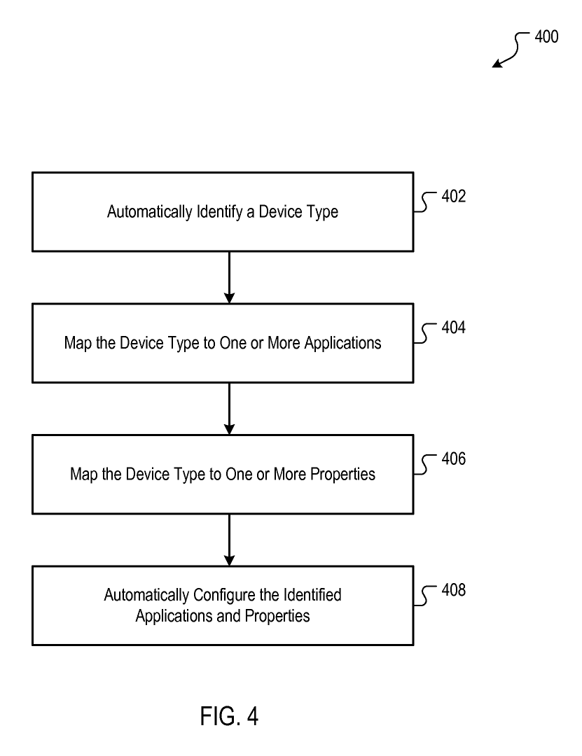

FIG. 4 is a flow chart illustrating an example method 400 for automatically configuring a software stack in accordance with some implementations of the present disclosure. Generally, method 400 describes an example technique where a single software stack automatically configures applications in accordance with one of a plurality of different device types. System 100 contemplates using any appropriate combination and arrangement of logical elements implementing some or all of the described functionality.

The method 400 begins at step 402 where a software stack automatically identifies a device type in response to an event. For example, the mapping engine 114 of FIG. 1 may automatically identify a device type of the mobile device 102 in response to at least initialization. At step 404, the device type is mapped to one or more applications in the software stack. In the example, the mapping engine 114 may map the device type to a subset of the applications 110 that is less than all of the applications 110. Next, at step 406, the mapping engine 114 maps the device type to one or more properties of the applications. As for the example, the mapping engine 114 may map the device type to one or more properties 112 of the identified applications 110, which may include identifying instructions for configuring the one or more properties 112. In accordance with the device type, the identified applications and properties are automatically configured for execution in the device at step 408. Returning to the example, the mapping engine 114 may automatically configure the identified applications 110 and properties 112 for executing by the mobile device 102 in accordance with the device type.

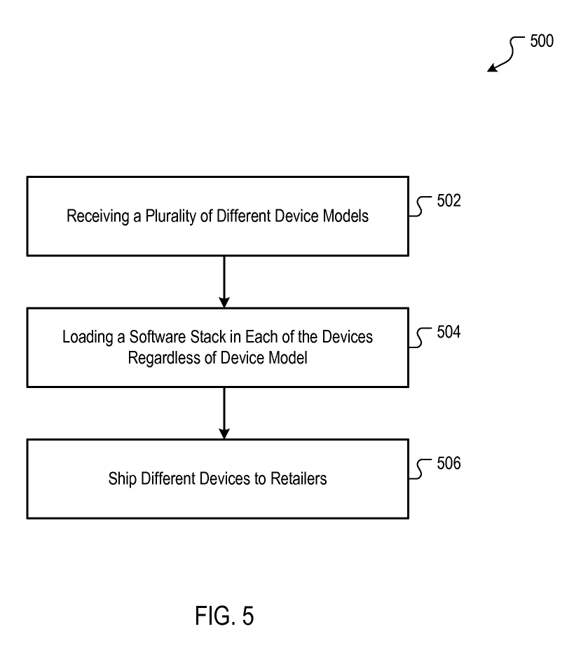

FIG. 5 is a flow chart illustrating an example method 500 for loading a software stack in accordance with some implementations of the present disclosure. Generally, the method 500 describes an example technique where a single software stack is automatically loaded in a plurality of different device models. System 100 contemplates using any appropriate combination and arrangement of logical elements implementing some or all of the described functionality.

The method 500 begins at step 502 where a plurality of different mobile devices are received. For example, the different mobile devices may be received from a plurality of manufacturers and/or manufacturing facilities. In regards to FIGS. 2A and 2B, mobile devices 102a may be received from one manufacturing facility while the mobile devices 102b may be received from a different manufacturing facility. Next, at step 504, the same software stack is loaded in each of the different mobile devices regardless of the device model. As mentioned above, the software stack 104 may be loaded in different device models even though the device models may execute different software applications 110 and/or applications 110 with different properties 112. At step 506, the devices are shipped to retailers independent of manually configuring the software stacks. For example, the mobile devices 102a and 102b may be shipped to the same or different retailers without manually configuring the software stack 104. In this case, the software stack 104 may automatically configure the applications 110 associated with the device model in response to at least initialization.

A number of implementations of the invention have been described. Nevertheless, it will be understood that various modifications may be made without departing from the spirit and scope of the invention. Accordingly, other implementations are within the scope of the following claims.

What is claimed is:

1. A software stack comprising computer readable instructions embodied on media and operable to:
automatically identify one or more applications in the software stack based, at least in part, on at least one of a plurality of identifiable device models or types, wherein the software stack is stored in a device; and
automatically configure the one or more applications for execution in the device in accordance with the identified device model, wherein each of the plurality of identifiable device models is associated with a different configuration of the software stack.

2. The software stack of claim 1, wherein the one or more applications are identified based, at least in part, on hardware components included in the device.

3. The software stack of claim 1, further operable to automatically determine a device model of the device in response to at least in an event.

4. The software stack of claim 3, wherein the event is at least one of initialization or activation of the device.

5. The software stack of claim 1, wherein the software operable to automatically identify the one or more applications comprises the software operable to automatically map the identified device model to a subset of applications in the software stack, wherein the subset of applications in less than all applications in the software stack.

6. The software stack of claim 1, further comprising:
automatically identify one or more properties of the identified applications based, at least in part, on the identified device model; and
automatically configure the one or more properties in accordance with the identified device model.

7. The software stack of claim 6, wherein the one or more properties are configured based, at least in part, on hardware components included in the device.

8. The software stack of claim 1, wherein the device is at least one of a personal digital assistant, a cellular telephone, a smart phone, an EGPRS mobile phone, or a media player.

9. The software stack of claim 1, further comprising:
receive information modifying a configuration associated with the identified device model; and
automatically re-configure at least one application based, at least in part, on the updated configuration.

10. The software stack of claim 1, wherein the software operable to automatically configure the one or more applications comprises the software operable to publish configuration instructions for the one or more identified applications such that the one or more identified applications self-configure based, at least in part, on the published instructions.

11. The software stack of claim 1, further operable:
automatically determine a device is one of a plurality of identifiable of identifiable device types; and
in response to at least identifying the device type, automatically identify a plurality of capabilities in accordance with the device type, wherein the one or more applications in the software stack are identified based on the identified plurality of capabilities.

12. The software stack of claim 11, wherein the identified plurality of capabilities is based, at least in part, on a generation of the device type.

13. The software stack of claim 11, wherein the identified plurality of capabilities is based, at least in part, on a geographic location associated with use of the device.

14. The software stack of claim 11, wherein the plurality of capabilities include at least one of a camera, telephone, or a 30-pin-device connector.

15. The software stack of claim 11, wherein the software operable to automatically identify a plurality of capabilities comprises the software operable to determine one of a plurality of a plurality of identifiable lists, wherein each list is associated with a different device type.

16. The software stack of claim 15, wherein the one of the plurality of identifiable lists identifies a different list associated with a different device type such that the one of the plurality of identifiable list inherits properties of the different list.

17. The software stack of claim 15, wherein the plurality of identifiable list comprises a plurality of identifiable property lists.

18. The software stack of claim 1, further operable to:
automatically determine a device is one of a plurality of identifiable of identifiable device types;
change the one of a plurality of identifiable of identifiable device types to a different device type; and
automatically identify a plurality of capabilities in accordance with the different device type for the one of a plurality of identifiable of identifiable device types.

19. The software stack of claim 18, wherein the one of a plurality of identifiable of identifiable device types is changed to the different device type in accordance with an identified preference.

20. A method, comprising:
receiving a plurality of mobile devices with each device associated with a different device model;
loading a same software stack in each of the plurality of mobile devices independent of the different device models, wherein the plurality of mobile devices execute at least one application included in the same software stack with different properties; and
shipping the plurality of mobile devices to retailers without manually configuring the same software stack.

21. The method of claim 20, wherein the same software stack includes a plurality of applications and is operable to automatically configure one or more of the applications based, at least in part, on a device model.

22. A method for configuring devices, comprising:
automatically identifying one or more applications in the software stack based, at least in part, on at least one of a plurality of identifiable device models or types, wherein the software stack is stored in a device; and
automatically configuring the one or more applications for execution in the device in accordance with the identified device model, wherein each of the plurality of identifiable device models is associated with a different configuration of the software stack.

23. The method of claim 22, wherein the one or more applications are identified based, at least in part, on hardware components included in the device.

24. The method of claim 22, further automatically determining a device model of the device in response to at least in an event.

25. The method of claim 24, wherein the event is at least one of initialization or activation of the device.

26. The method of claim 22, wherein automatically identifying the one or more applications comprises automatically mapping the identified device model to a subset of applications in the software stack, wherein the subset of applications in less than all applications in the software stack.

27. The method of claim 22, further comprising:
automatically identifying one or more properties of the identified applications based, at least in part, on the identified device model; and
automatically configuring the one or more properties in accordance with the identified device model.

28. The method of claim 27, wherein the one or more properties are configured based, at least in part, on hardware components included in the device.

29. The method of claim 22, wherein the device is at least one of a personal digital assistant, a cellular telephone, a smart phone, an EGPRS mobile phone, or a media player.

30. The method of claim 22, further comprising:
receiving information modifying a configuration associated with the identified device model; and
automatically re-configuring at least one application based, at least in part, on the updated configuration.

31. The method of claim 22, wherein automatically configuring the one or more applications comprises publishing configuration instructions for the one or more identified applications such that the one or more identified applications self-configure based, at least in part, on the published instructions.

32. A system for configuring devices, comprising:
a means for automatically identifying one or more applications in the software stack based, at least in part, on at least one of a plurality of identifiable device models or types, wherein the software stack is stored in a device; and
a means for automatically configuring the one or more applications for execution in the device in accordance with the identified device model, wherein each of the plurality of identifiable device models is associated with a different configuration of the software stack.
